(19) United States
(12) Patent Application Publication
(10) Pub. No.: US 2019/0324117 A1
(43) Pub. Date: Oct. 24, 2019

(54) CONTENT AWARE AUDIO SOURCE LOCALIZATION

(71) Applicant: MediaTek Inc., Hsinchu (TW)

(72) Inventors: Che-Kuang Lin, New Taipei (TW); Liang-Che Sun, Taipei (TW); Yiou-Wen Cheng, Hsinchu (TW)

(21) Appl. No.: 15/960,962

(22) Filed: Apr. 24, 2018

(51) Int. Cl. G01S 5/26; H04S 7/00

(52) U.S. Cl. CPC G01S 5/26; H04S 2400/15; H04S 7/303

(57) ABSTRACT

A device is operative to locate a target audio source. The device includes multiple microphones arranged in a predetermined geometry. The device also includes a circuit operative to receive multiple audio signals from each of the microphones. The circuit is operative to estimate respective directions of audio sources that generate at least two of the audio signals; identify candidate audio signals from the audio signals in the directions; match the candidate audio signals with a known audio pattern; and generate an indication of a match in response to one of the candidate audio signals matching the known audio pattern.

### TECHNICAL FIELD

Embodiments of the invention relate to audio signal processing systems and methods performed by the systems for separating audio sources and locating a target audio source.

### BACKGROUND

Separating audio sources from interferences and background noise is a challenging problem especially when computation complexity is a concern. Blind source separation is a technique field that studies the separation of signal sources from a set of mixed signals without or with very little information about the signal sources. Known techniques for blind source separation can be complex and may not be suitable for real-time applications.

One application for audio source separation is to isolate the speech of a single person at a cocktail party where there is a group of people talking at the same time. Humans can easily concentrate on an audio signal of interest by “tuning into” a single voice and “tuning out” all others. By comparison, machines typically are poor at this task.

### SUMMARY

In one embodiment, a device is provided to locate a target audio source. The device comprises a plurality of microphones arranged in a predetermined geometry; and a circuit operative to receive a plurality of audio signals from each of the microphones; estimate respective directions of audio sources that generate at least two of the audio signals; identify candidate audio signals from the audio signals in the directions; match the candidate audio signals with a known audio pattern; and generate an indication of a match in response to one of the candidate audio signals matching the known audio pattern.

In another embodiment, a method is provided for locating a target audio source. The method comprises: receiving a plurality of audio signals from each of a plurality of microphones; estimating respective directions of audio sources that generate at least two of the audio signals; identifying candidate audio signals from the audio signals in the directions; matching the candidate audio signals with a known audio pattern; and generating an indication of a match in response to one of the candidate audio signals matching the known audio pattern.

The device and the method to be disclosed herein locate a target audio source from a noisy environment by performing computations in real-time.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a system in which embodiments of the invention may operate.

FIGS. 2A-2D illustrate arrangements of microphones according to some embodiments.

FIG. 3 illustrates a process for locating a target audio source according to one embodiment.

FIG. 4 is a schematic diagram of functional blocks that perform the process of FIG. 3 according to one embodiment.

FIG. 5 illustrates details of delay calculations according to an embodiment.

FIG. 6 illustrates additional details of delay calculations according to an embodiment.

FIG. 7 illustrates a Convolutional Neural Network (CNN) circuit for locating a target audio source according to one embodiment.

FIG. 8 is a flow diagram illustrating a method for locating a target audio source according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a device or system, and a method thereof, which locates an audio source of interest (referred hereinafter as “target audio source”) based on one or more known audio patterns. The term “locate” hereinafter means “the identification of the direction” of a target audio source or the signal generated by the target audio signal. The direction may be used to isolate or extract the target audio signal from the surrounding signals. The audio pattern may include features in the time-domain waveform and/or the frequency-domain spectrum that are indicative of a desired audio content. The audio content may contain a keyword, or may contain unique sounds of a speaker or an object (such as a doorbell or alarm).

In one embodiment, the device includes an array of microphones, which detect and receive audio signals generated by the surrounding audio sources. The time delays that an audio signal arrives at different microphones can be used to estimate the direction of arrival of that audio signal. The device then identifies and extracts an audio signal in each estimated direction, and matches the extracted audio signal with a known audio pattern. When a match is found, the device may generate a sound, light or other indications to signal the match. The device is capable locating a target audio source from an environment that is filled with noise and interferences, such as in a “cocktail party” environment.

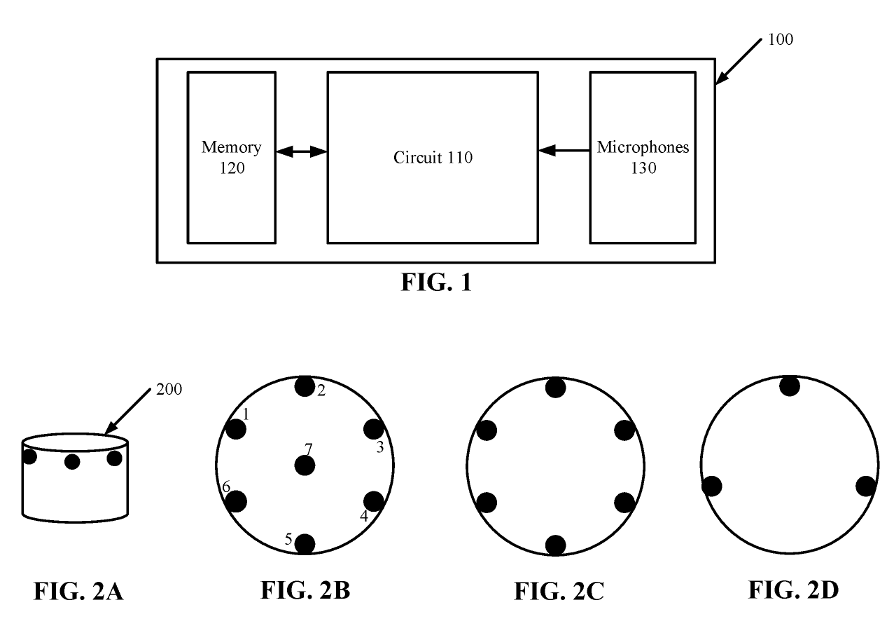

FIG. 1 illustrates a schematic diagram of a system 100 in which embodiments of the invention may operate. The system 100, which may also be referred to as a device, includes a circuit 110 coupled to a memory 120 and a plurality of microphones 130. The circuit 110 may further includes one or more processors 110, such as one or more central processing units (CPUs), digital signal processing (DSP) units, and/or other general-purpose or special purpose processing circuitry. Non-limiting examples of the memory 120 include dynamic random access memory (DRAM), static RAM (SRAM), flash memory and other volatile and non-volatile memory devices. The microphones 130 may be arranged in an array of one, two, or three dimensions. Each of the microphones 130 may detect and receive multiple audio signals from multiple directions. It is understood that the embodiment of FIG. 1 is simplified for illustration purposes. Additional hardware components may be included in the system 100.

FIGS. 2A-2D illustrate arrangements of the microphones 130 in the system 100 according to some embodiments. In the example of FIG. 2A, a device 200 (which is an example of the system 100) is encased in a cylindrical housing, with the microphones (shown as black dots) embedded in the periphery. It is understood that the housing of the system 100 can be any geometrical shape. It is also understood that the microphones can be arranged in a number of geometrical configurations, and can be embedded in any parts of the device 200.

FIGS. 2B-2D show further examples of the microphone configurations from the top view of the device 200. In the example of FIG. 2B, the microphones are arranged in a star-like configuration, with a microphone 7 in the center and the other microphones 1-6 arranged in a circle surrounding the center. In the example of FIG. 2C, the microphones are arranged in a circle without a center microphone. In the example of FIG. 2D, three microphones are arranged in a triangle.

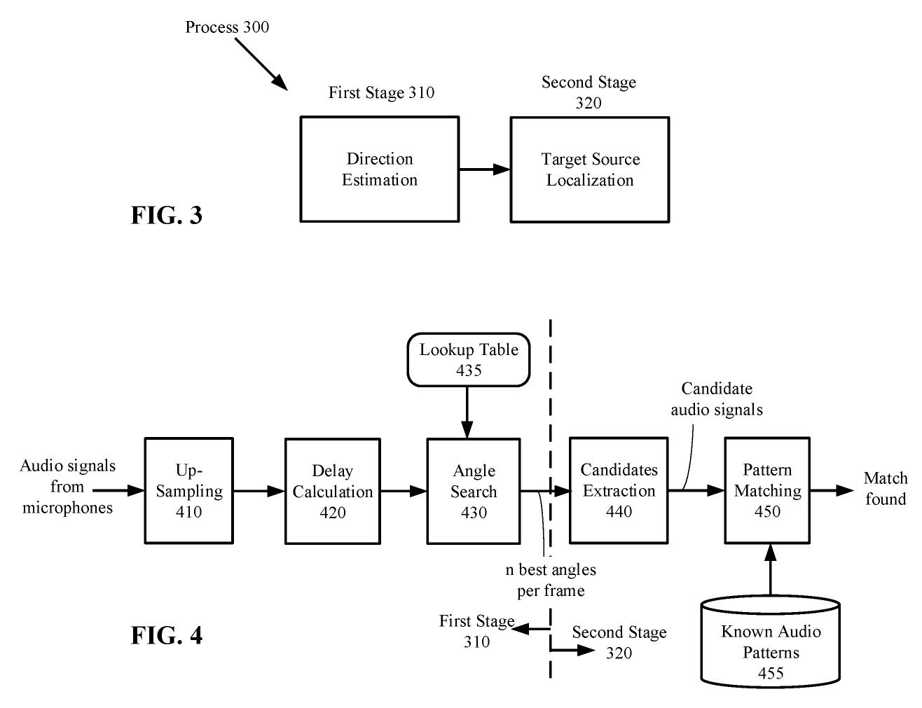

FIG. 3 illustrates a process 300 performed by the circuit 110 of FIG. 1 for locating a target audio source according to one embodiment. The process 300 includes two stages: the first stage 310 is direction estimation and the second stage 310 is target source identification. The process 300 may be repeated for each frame of microphone signals. Details of each of the stages will be described below with reference to FIGS. 4-6.

As used herein, the term “audio signal” refers to the sound generated by an audio source, and the term “microphone signal” refers to the signal received by a microphone. Each microphone signal may be processed one time period at a time, where each time period is referred to as a time frame or a frame.

FIG. 4 is a schematic diagram of functional blocks that perform the process 300 according to one embodiment. Blocks 410-430 show details of the first stage 310 and blocks 440 and 450 show details of the second stage 320. Each block (410-450) may be a functional unit implemented by hardware components, a software function executable by the circuit 110 (FIG. 1), or a combination of both. Assume that the number of microphones 130 in the embodiment of FIG. 1 is m, where m is at least two. The up-sampling block 410 receives m microphone signals from the m microphones and up-samples the microphone signals. The up-sampling increases the resolution of the microphone signals (e.g., from 16 samples per second to 128 samples per second), which improves the resolution of the delays to be calculated. The term “delay” herein refers to the time of arrival of an audio signal at a microphone relative to a reference point. The up-sampling may be performed by inserting zeros between the received microphone signal samples. However, the insertion of zeros introduces aliases, which can be removed by one or more low-pass filters (e.g., a poly-phase subband filter, a finite-impulse response (FIR) filter, and the like). The up-sampled signals are used by the delay calculation block 420 for delay calculations.

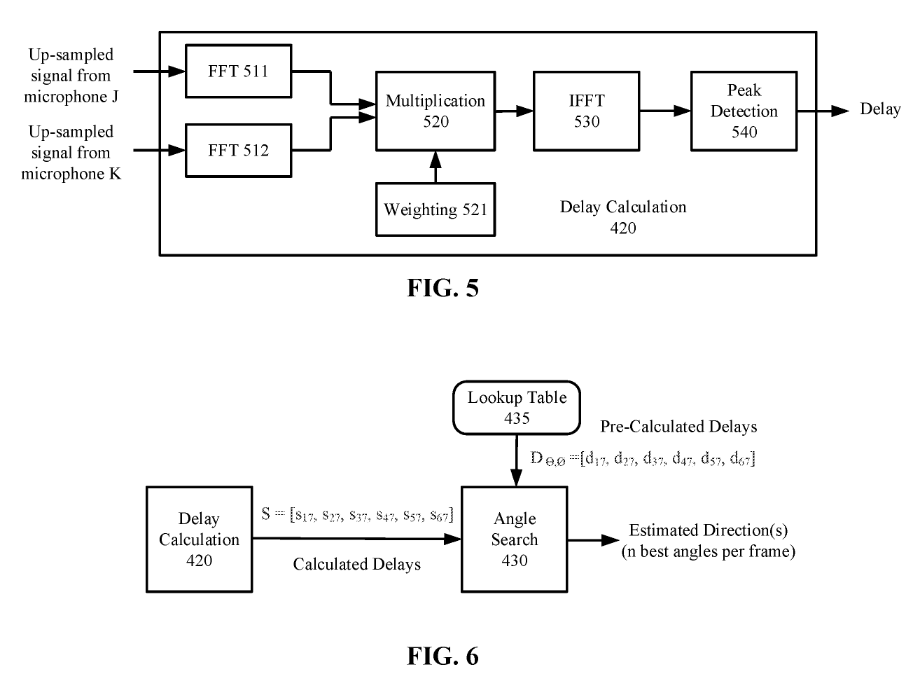

FIGS. 5 and 6 illustrates further details of the delay calculations according to one embodiment. Referring to FIG. 5, the delay calculation block 420 performs delay calculations for the microphone signals in each frame. In one embodiment, the delay calculations may be performed on each pair of microphones. A “microphone pair” refers to any two of the microphones in the system, such as any two of them microphones 130 of FIG. 1. A “microphone pair” refers to any two of the microphones in the system. For example, if m=3, there will be three pairs of microphones. A “microphone signal pair” refers to the microphone signals received by a microphone pair. In one embodiment, the delay calculation block 420 may calculate the delays for all pairs of microphones in the system 100. Alternatively, only a subset of the pairs are used for delay calculations. For example, in FIG. 2B, the delay calculation block 420 may calculate the delays between all combinations of microphone pairs; alternatively, the delay calculation block 420 may calculate the delays between the center microphone 7 and each of the microphones (1-6) in the circle, which is 7 pairs in total. In the former case, the reference point for the delay calculation may change from one microphone pair to the next; in the latter case, the reference point is fixed (e.g., the center microphone 7).

In the embodiment of FIG. 5, the delay calculation block 420 first transforms a pair of microphone signals in a frame into frequency domain data points, e.g., by Fast Fourier Transform (FFT) 511 and 512. Each data point in the frequency domain represents the energy at a frequency, or in a range of frequencies, which is referred to as a bin. The frequency domain data points from each microphone pair are multiplied by a multiplication block 520; e.g., the data points from microphone J is multiplied with the data points from microphone K in the frequency domain. In one embodiment, the data points from each microphone may be weighted to enhance the signal in one frequency band and to suppress the signal in one or more other frequency bands. In one embodiment, the weighting block 521 is used to enhance the frequency band that contains the known audio pattern. That is, a frequency band can be selected according to the known audio characteristics to be identified. Alternatively or additionally, the weighting block 521 is used to perform frequency band separation, such that audio signals are separated by frequency bands to improve computation efficiency in subsequent calculations. The weighting block 521 may include multiple filters with each filter allow passage of a different frequency band, e.g., a high-pass filter, a low-pass filter and band-pass filter, etc.

Following the frequency domain multiplication, Inverse FFT (IFFT) 530 transforms the multiplication result of each microphone pair back to time domain data. The peak detection block 540 detects a peak in the time domain data for each microphone pair. The location of the peak (e.g., at 1/32th sample time) is the time delay between the microphone signal pair. The delay calculation block 420 of FIG. 5 is repeated for multiple microphone pairs. In some embodiments, the delays may be calculated for C(m, 2) microphone pairs, where C (m, 2) is a combinatorics notation representing the number of combinations of any two elements from a set of m elements (i.e., m microphones). In some embodiments, the delays may be calculated for a subset of the C(m, 2) microphone pairs.

For example, in the embodiment of FIG. 2B, the delays may be calculated from six microphone pairs such as microphone pairs (1, 7), (2, 7), (3, 7), (4, 7), (5, 7), (6, 7). The six delays calculated from the six microphone pairs are represented by a set: S={S17, S27, S37, S47, S57, S67}, where Sjk represents the delay between microphone j and microphone k. The angle search block 430 of FIGS. 4 and 6 searches a lookup table 435 in a memory to find a match for S. In one embodiment, the lookup table 435 stores a set of pre-calculated delays for each microphone pair and each predetermined angle of direction. In one embodiment, the lookup table 435 stores, for each direction in a set of predetermined directions, a set of pre-calculated delays of an audio signal that arrives at the microphones 130 from the direction. In one embodiment, each pre-calculated delay is a time-of-arrival difference between the audio signal arriving at one of the microphones 130 and arriving at a reference point. In the example configuration of FIG. 2B, the reference point is the center microphone 7. In the example configuration of FIG. 2C, the reference point may be the center of the circle formed by microphones 1-6, even though there is no microphone at the center. In some embodiments, the reference point may be the center point of the geometry formed by the microphones 130.

In an alternative embodiment, there may be no fixed reference point. Each time delay is a time-of-arrival difference for the audio signal arriving at two of the microphones 130 (also referred to as a microphone pair). For each direction in a set of predetermined directions, the lookup table 435 may store a set of pre-calculated delays for a set of microphone pairs, where the set of microphone pairs include different combinations of any two of the microphones 130. In this alternative embodiment, each pre-calculated delay is a time-of-arrival difference between the audio signal arriving at one of the microphones and another of the microphones.

The set of directions for which the lookup table 435 stores the pre-calculated delays may include a fixed increment of angles in the spherical coordinate system. For example, each of the spherical angles θ and Ø may be incremented by 15 degrees from zero degrees to 180 degrees such that the lookup table 435 includes (180/15)×(180/15)=144 predetermined directions in total. The estimated direction is one of the predetermined directions. The resolution of the estimated direction is therefore limited by the angle increment resolution. Thus, in this example, the resolution of the estimated direction is limited to 15 degrees.

For example, let D_{θ,Ø}={D17, D27, D37, D47, D57, D67} represent an entry of the lookup table 430 for the spherical angles θ and Ø, where microphone 7 is the reference point. The angle search block 430 finds an entry D_{θ,Ø} that minimizes the difference |D_{θ,Ø}−S|; thus, the estimated direction is arg(min_{θ,Ø}(|D_{θ,Ø}−S|)). In this example, each of the directions is defined by a combination of spherical angles. Although spherical angles are used in this example to define and determine a direction, it is understood that the operations described herein are applicable to a different coordinate system using different metrics for representing and determining a direction.

It is noted that the operations of the IFFT 530 and the peak detection block 540 are repeated for each microphone pair. In addition, the operations of the IFFT 530, the peak detection block 540 and the angle search block 430 is also repeated for each frequency band that is separated by the weighting block 521 and may contain the known audio pattern. Thus, the angle search block 430 may continue to find additional entries in the lookup table 430 for additional sets of pre-calculated delays D_{θ,Ø} to match additional sets of calculated delays S for additional directions. In total, the angle search block 430 may find N such table entries (N is any positive number) which represent N estimated directions, referred herein as N best directions. The N best directions are the output of the first stage 310 of the process 300 in FIG. 3.

Referring again to FIG. 4, the second stage 320 of the process 300 is shown at the right hand side of the dotted dividing line according to one embodiment. After the estimation of directions, the candidate extraction block 440 applies to each microphone signal a different weight and sums up the weighted microphone signals to calculate a candidate audio signal. The weighted sum compensates the delays among the different microphone signals, and as a result, enhance the audio signal in its estimated direction and suppress signals and noise in other directions. In other words, the candidate extraction block 440 constructively combines the signals from each microphone to enhance the signal-to-noise ratio (SNR) of the received audio signal in a given direction, and destructively combine the microphone signals in other directions. The candidate extraction block 440 extracts a candidate audio signal in each of the N best directions. The weights used by the candidate extraction block 440 are derived from the coordinates of each of the N best directions. In one embodiment, the candidate extraction block 440 may apply the weighted sum to the filtered signals that are separated by frequency bands by the weighting block 521 of FIG. 5.

The pattern matching block 450 matches (e.g., by calculating a correlation of) each candidate audio signal with a known audio pattern. For example, the known audio pattern may be an audio signal of a known command or keyword, a speaker's voice, a sound of interest (e.g., doorbell, phone ringer, smoke detector, music, etc.). For example, the keyword may be “wake up” and the known audio pattern may be compiled from users of different ages and genders saying “wake up.” Known audio patterns 455 may be pre-stored by the manufacturer in a storage, which may be in the memory 120 (FIG. 1). In some embodiments, the known audio patterns 455 may be generated by the system 100 during a training process with a user. A user may also train the system 100 to recognize his/her voice and store his/her audio characteristics as part of the known audio patterns 455. The audio signal detected in each estimated direction is matched (e.g., correlated) with the known audio patterns and a matching score may be generated. If the matching score between a candidate audio signal and a known audio pattern is above a threshold (i.e., when a match is found), the audio source generating the candidate audio signal is identified as the target audio source.

In one embodiment, when a match is found, the system 100 may generate an indication such as a sound or light to alert the user. The system 100 may repeat the process 300 of FIG. 3 to locate additional target audio sources.

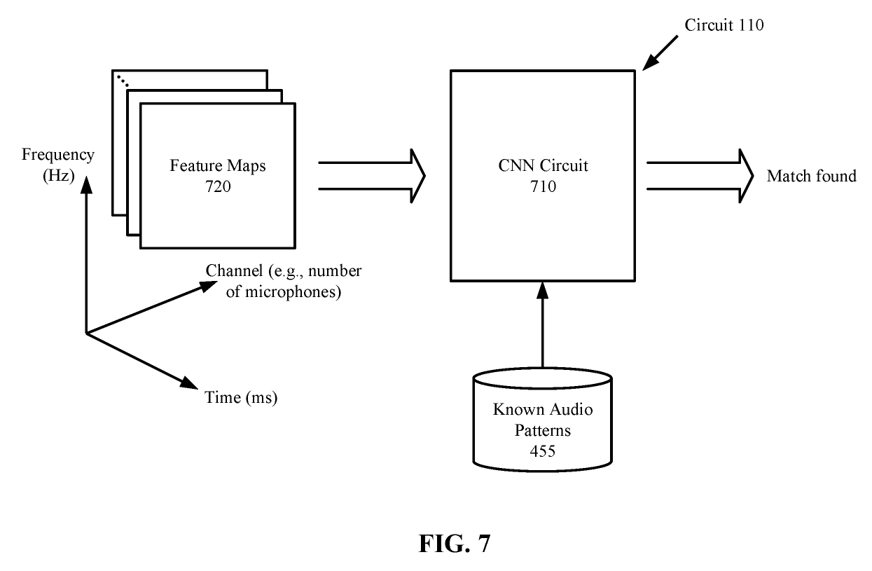

In some embodiments, the circuit 110 of FIG. 1 may include a Convolutional Neural Network (CNN) circuit. FIG. 7 illustrates a CNN circuit 710 for locating a target audio source according to one embodiment. The CNN circuit 710 performs the process 300, including direction estimation and target source localization of FIG. 3 by a sequence of 3D convolutions. More specifically, the CNN circuit 710 performs 3D convolutions, max pooling and class scores computations. The 3D convolutions convolves input feature maps with a set of filters over a set of channels (e.g., microphones), the max pooling down-samples each feature map to reduce the dimensionality, and the class scores computations using fully-connected layers to compute a probability (i.e., score) for each candidate audio signal. The candidate audio signal receiving the highest score is the target audio signal.

In one embodiment, the circuit 110 may include general-purpose or special-purpose hardware components for each of the functional blocks 410-450 (FIG. 4) performing the operations described in connection with FIGS. 4-6, and may additionally include the CNN circuit 710. The system 100 may selectively enable either the functional blocks 410-450 or the CNN circuitry for locating a target audio source. In one embodiment, the CNN circuit 710 may be enabled when the system 100 determines from the estimated directions that the number of audio sources is above a threshold. Alternatively, the CNN circuit 710 may be enabled when the audio signals are buried in noise and/or interferences and are not discernable or separable from one another (e.g., when the functional blocks 410-450 fail to produce a result for a period of time).

In one embodiment, the input to the CNN circuit 710 is arranged as a plurality of feature maps 720. Each feature map 720 corresponds to a channel and has a time dimension and a frequency dimension, where each channel corresponds to one of the microphones 130 of FIG. 1. Each feature map 720 in the time dimension is a sequence of frames, and in the frequency dimension is the frequency spectrum of the frames. The CNN circuit 710 receives the feature maps 720 as input, and convolves each feature map with 2D filters followed by max pooling and class scores computations. The coefficients of the 2D filters may be trained in a training process of the CNN circuit 710. The training process may be performed by a manufacture of the system 100, such that the CNN circuit 710 is already trained to localize an audio pattern, such as keyword sound and other audio signals of interest, when the system 100 is shipped to a user. Additionally, the CNN circuit 710 may be trained by a user to recognize his/her voice. As a result of the training, the CNN circuit 710 is capable of recognizing a target audio signal that matches any of the known audio patterns 455 (FIG. 4). In one embodiment, the set of 2D filters may include two subsets; the first subset of filters are trained to estimate audio signal directions and the second subset of filters are trained to assigned a score to the audio signal in each estimated direction, where the score indicates how close the match is between the signal and a known signal pattern. In one embodiment, in response to a score greater than a threshold, the system 100 generates an indication of match in the form of a sound and/or light to indicate that a target audio source has been identified.

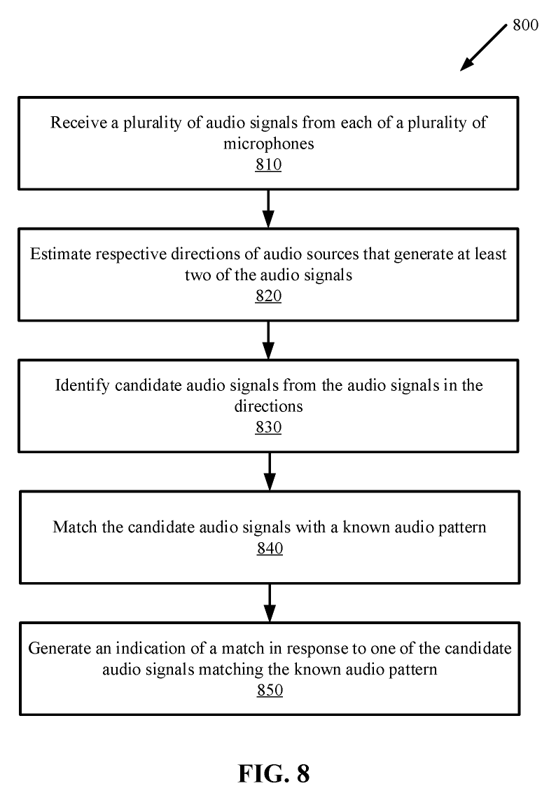

FIG. 8 is a flow diagram illustrating a method 800 for localizing a target signal source according to one embodiment. The method 800 may be performed by a circuit, such as the circuit 110 of FIG. 1 or FIG. 7.

The method 800 begins at step 810 when the circuit receives a plurality of audio signals from each of a plurality of microphones (e.g., the microphones 130 of FIG. 1). Each microphone may receive a desired audio signal plus other unwanted signals such as noise and interferences. The circuit at step 820 estimates respective directions of audio sources that generate at least two of the audio signals. The circuit at step 830 identifies candidate audio signals from the audio signals in the directions. The circuit at step 840 matches the candidate audio signals with a known audio pattern. If one of the candidate audio signals matches the known audio pattern, the circuit at step 850 generates an indication of a match.

The operations of the flow diagram of FIG. 8 has been described with reference to the exemplary embodiments of FIGS. 1 and 7. However, it should be understood that the operations of the flow diagram of FIG. 8 can be performed by embodiments of the invention other than the embodiments of FIGS. 1 and 7, and the embodiments of FIGS. 1 and 7 can perform operations different than those discussed with reference to the flow diagram. While the flow diagram of FIG. 8 shows a particular order of operations performed by certain embodiments of the invention, it should be understood that such order is exemplary (e.g., alternative embodiments may perform the operations in a different order, combine certain operations, overlap certain operations, etc.).

The process 300 and the method 800 described herein can be implemented with any combination of hardware and/or software. In one particular approach, elements of the process 300 and/or the method 800 may be implemented using computer instructions stored in non-transitory computer readable medium such as a memory, where the instructions are executed on a processing device such as a microprocessor, embedded circuit, or a general-purpose programmable processor. In another approach, special-purpose hardware may be used to implement the process 300 and/or the method 800.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A device operative to locate a target audio source, comprising:
a plurality of microphones arranged in a predetermined geometry; and
a circuit operative to:
receive a plurality of audio signals from each of the microphones;
estimate respective directions of audio sources that generate at least two of the audio signals;
identify candidate audio signals from the audio signals in the directions;
match the candidate audio signals with a known audio pattern; and
generate an indication of a match in response to one of the candidate audio signals matching the known audio pattern.

2. The device of claim 1, wherein each of the directions is defined by a combination of spherical angles.

3. The device of claim 1, wherein the known audio pattern is an audio signal having known features in at least one of: a time-domain waveform and a frequency-domain spectrum, wherein the features are indicative of a desired audio content.

4. The device of claim 1, further comprising:
memory to store a lookup table including, for each of a plurality of predetermined directions, a set of pre-calculated delays of an audio signal that arrives at the microphones from the predetermined direction.

5. The device of claim 4, wherein the set of pre-calculated delays include a time-of-arrival difference between the audio signal arriving at one of the microphones and arriving at a center point of a geometry formed by the microphones.

6. The device of claim 4, wherein the set of pre-calculated delays includes a time-of-arrival difference between the audio signal arriving at one of the microphones and arriving at another of the microphones.

7. The device of claim 1, wherein the circuit further comprises hardware components operative to calculate a set of delays of the audio signals arriving at the microphones, and match the set of delays with a set of pre-calculated delays to identify a predetermined direction corresponding to the set of pre-calculated delays, wherein the predetermined direction is identified as a direction of one of the audio sources.

8. The device of claim 1, wherein the circuit further comprises hardware components operative to:
apply low-pass filtering to the audio signals;
enhance a first portion of a frequency spectrum of the audio signals, where the first portion of the frequency spectrum matches a frequency band containing the known signal pattern; and
calculate a set of delays of the audio signals arriving at the microphones after the low-pass filtering and enhancement of the first portion of a portion of the frequency spectrum.

9. The device of claim 1, wherein the circuitry further comprises:
a convolutional neural network (CNN) circuit to perform 3D convolutions on the audio signals.

10. The device of claim 9, wherein input to the CNN circuit is arranged into feature maps that has a time dimension, a frequency dimension and a channel dimension, wherein the channel dimension includes a plurality of channels that correspond to the plurality of microphones.

11. A method for localizing a target audio source, comprising:
receiving a plurality of audio signals from each of a plurality of microphones;
estimating respective directions of audio sources that generate at least two of the audio signals;
identifying candidate audio signals from the audio signals in the directions;
matching the candidate audio signals with a known audio pattern; and
generating an indication of a match in response to one of the candidate audio signals matching the known audio pattern.

12. The method of claim 11, wherein each of the directions is defined by a combination of spherical angles.

13. The method of claim 11, wherein the known audio pattern is an audio signal having known features in at least one of: a time-domain waveform and a frequency-domain spectrum, wherein the features are indicative of a desired audio content.

14. The method of claim 11, further comprising:
searching a lookup table to estimate the respective directions, wherein the lookup table including, for each of a plurality of predetermined directions, a set of pre-calculated delays of an audio signal that arrives at the microphones from the predetermined direction.

15. The method of claim 14, wherein the set of pre-calculated delays includes a time-of-arrival difference between the audio signal arriving at one of the microphones and arriving at a center point of a geometry formed by the microphones.

16. The method of claim 14, wherein the set of pre-calculated delays includes a time-of-arrival difference between the audio signal arriving at one of the microphones and arriving at another of the microphones.

17. The method of claim 11, wherein estimating the respective directions further comprises:
calculating a set of delays of the audio signals arriving at the microphones; and
matching the set of delays with a set of pre-calculated delays to identify a predetermined direction corresponding to the set of pre-calculated delays, wherein the predetermined direction is identified as a direction of one of the audio sources.

18. The method of claim 11, wherein estimating the respective directions further comprises:
applying low-pass filtering to the audio signals;
enhancing a first portion of a frequency spectrum of the audio signals, where the first portion of the frequency spectrum matches a frequency band containing the known signal pattern; and
calculating a set of delays of the audio signals arriving at the microphones after the low-pass filtering and enhancement of the first portion of a portion of the frequency spectrum.

19. The method of claim 11, wherein a convolutional neural network (CNN) performs operations of estimating the respective directions, identifying the candidate audio signal, and matching the candidate audio signals with the known audio patterns.

20. The method of claim 19, wherein input to the CNN is arranged into feature maps that has a time dimension, a frequency dimension and a channel dimension, wherein the channel dimension includes a plurality of channels that correspond to the plurality of microphones.
